(19) United States
(12) Patent Application Publication
(10) Pub. No.: US 2014/0095327 A1
(43) Pub. Date: Apr. 3, 2014

(54) Apparatus and Method for Preserving Advertisements in a Web Page with Dynamically Served Advertisements

(71) Applicant: MARTINI MEDIA NETWORK, INC., San Francisco, CA (US)

(72) Inventors: Manicka Babu Muthugopalakrishnan, Fremont, CA (US); Keith Tak Kun Wu, Fremont, CA (US); Siddharth Srinivasa Ramu, Cupertino, CA (US)

(73) Assignee: MARTINI MEDIA NETWORK, INC., San Francisco, CA (US)

(21) Appl. No.: 13/633,842

(22) Filed: Oct. 2, 2012

(51) Int. Cl. G06Q 30/02

(52) U.S. Cl. CPC G06Q 30/0277
USPC 705/14.73

(57) ABSTRACT

A computer implemented method includes fetching a preserved advertisement specified by a first user, fetching a web page specified by the first user, positioning the preserved advertisement in the web page and delivering the preserved advertisement and the web page to a second user.

### FIELD OF THE INVENTION

This invention relates generally to content delivery in a computer network. More particularly, this invention relates to techniques for preserving advertisements in a web page with dynamically served advertisements.

### BACKGROUND OF THE INVENTION

The World Wide Web is widely used to explore content. Advertisements are a material aspect of this exploration process. For example, a user may find a web page with interesting content and an interesting advertisement accompanying the content. The user may want to share this information. This attempt to share the same experience may be thwarted by the fact that sharing a link to the web page is likely to result in the content on the web page being delivered with a different advertisement. Therefore, the subsequently accessed information will be different than the originally accessed information that the user wanted to share.

In view of the foregoing, it would be desirable to provide techniques that allow a user to share with others content originally experienced by the user.

### SUMMARY OF THE INVENTION

A computer implemented method includes fetching a preserved advertisement specified by a first user, fetching a web page specified by the first user, positioning the preserved advertisement in the web page and delivering the preserved advertisement and the web page to a second user.

A computer implemented method includes pulling a web page in response to a request, requesting an advertisement with an associated advertisement preservation script, combining the web page and the advertisement with the associated advertisement preservation script and delivering the web page and the advertisement with the associated advertisement preservation script.

### BRIEF DESCRIPTION OF THE FIGURES

The invention is more fully appreciated in connection with the following detailed description taken in conjunction with the accompanying drawings, in which:

FIG. 1 illustrates a network configured in accordance with an embodiment of the invention.

FIG. 2 illustrates processing operations associated with an embodiment of the invention.

FIG. 3 illustrates further processing operations associated with an embodiment of the invention.

Like reference numerals refer to corresponding parts throughout the several views of the drawings.

### DETAILED DESCRIPTION OF THE INVENTION

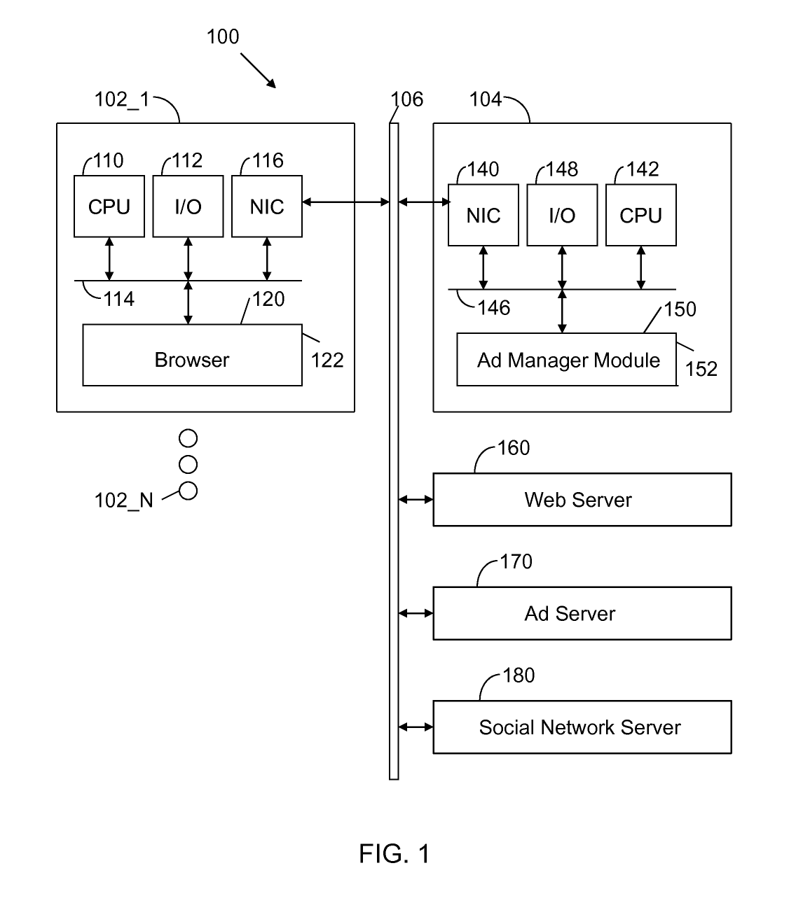

FIG. 1 illustrates a system 100 configured in accordance with an embodiment of the invention. The system includes a set of client devices 102_1 through 102_N that communicate with a server 104 through a network 106, which may be any wired or wireless network.

Each client device 102 includes standard components, such as a central processing unit and input/output devices 112 linked by a bus 114. The input/output device 112 may include a keyboard, mouse, touch display and the like. A network interface card 116 is also connected to the bus 114. The network interface card 116 provides connectivity to network 106.

A memory 120 is also connected to the bus 114. The memory stores executable programs, such as a browser 122. A client device 102 may be in any number of configurations, including a computer, a tablet, a mobile telephone and the like.

The server 104 also includes standard components, such as a central processing unit 142 and input/output devices 148 linked by a bus 146. A network interface circuit 140 is also connected to the bus 146 to provide connectivity to network 106. A memory 150 is also connected to the bus 146. The memory 150 stores executable programs, such as an advertisement manager module 152, which performs operations specified below. Server 104 is sometimes referred to herein as an advertisement manager in view of the advertisement manager module 152.

Other servers, illustrated in simplified form, may also be connected to the network 106. The additional servers may include a web server 160 for serving standard web content, an advertisement server 170 for dynamically supplying advertisements to a served web page, and a social network server 180 to provide social network experiences. For example, the social network server 180 may be a Facebook® server that allows a user to access his or her Facebook® wall with accompanying posts.

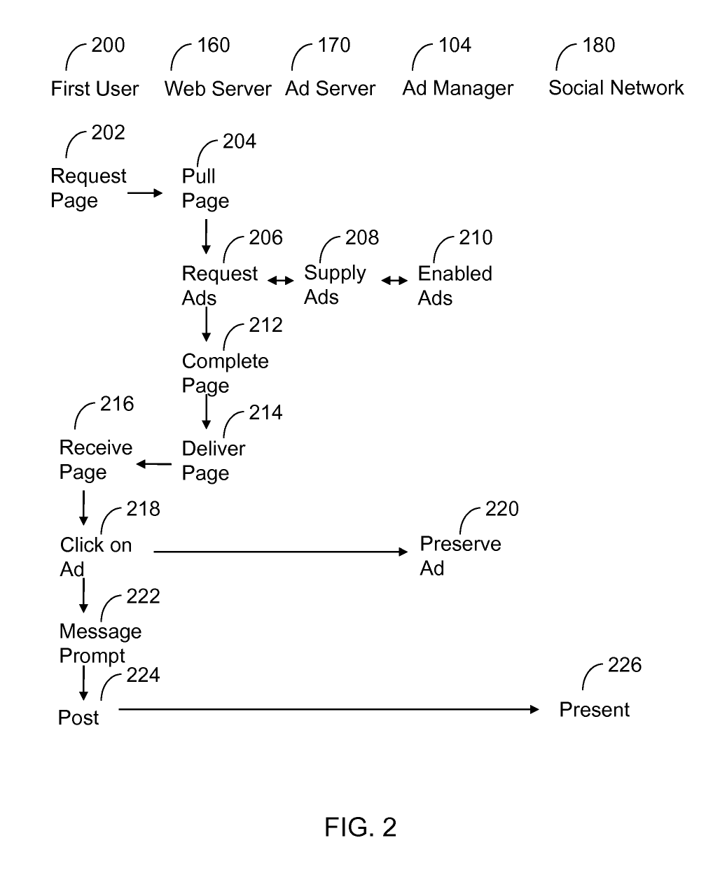

FIG. 2 illustrates processing operations implemented by the machines of FIG. 1. A first user 200 operates a client device 102. In particular, the first user 200 operates the client device 102 to request a web page 202. In this example, the web page resides at web server 160. The web server 160 pulls the specified page 204 and requests advertisements 206 to accompany the page. The advertisements may be served locally from web server 160 or they may be served by advertisement server 170. Calls to advertisement servers for this purpose are well known. The advertisement server 170 may access the advertisement manager module 152 of the server 104. The advertisement manager module 152 supplies at least one advertisement with an accompanying advertisement preservation script that is used to preserve an advertisement for future reference by another user, as explained below. In another embodiment of the invention, the advertisement with the accompanying advertisement preservation script is resident on the advertisement server 170. Therefore, the supply of advertisement preservation script enabled advertisements 210 shown in FIG. 2 does not result in a call to the advertisement manager 104.

The web page is then completed 212. That is, the web page content is supplemented with the fetched advertisement and accompanying advertisement preservations script. The completed page is then delivered 214. The first user 200 receives the page 216. The first user 200 clicks on the enabled advertisement 218. This invokes the script associated with the advertisement. The script includes a call to the advertisement manager 104, which preserves the advertisement 220. The script also includes a message prompt 222. For example, the message prompt may request a social network to which information should be posted and text to accompany the post. In one embodiment, the prompt lists a set of social networks that the user belongs to (e.g., Facebook®, Pintrest®, Twitter®). The use selects one or more such social networks. A text box may also be supplied to allow a user to enter text that will appear on the social network (e.g., “Check out this article on the Giants and the ad for their bobble head promotion.”). When the first user 200 has completed interactions with the prompt, the script operates to automatically post the content to the selected social networks. The post is then presented 226 on at least one social network 180. For example, the post may include the entered text and the link to the identified web page with the advertisement with the associated advertisement preservation script.

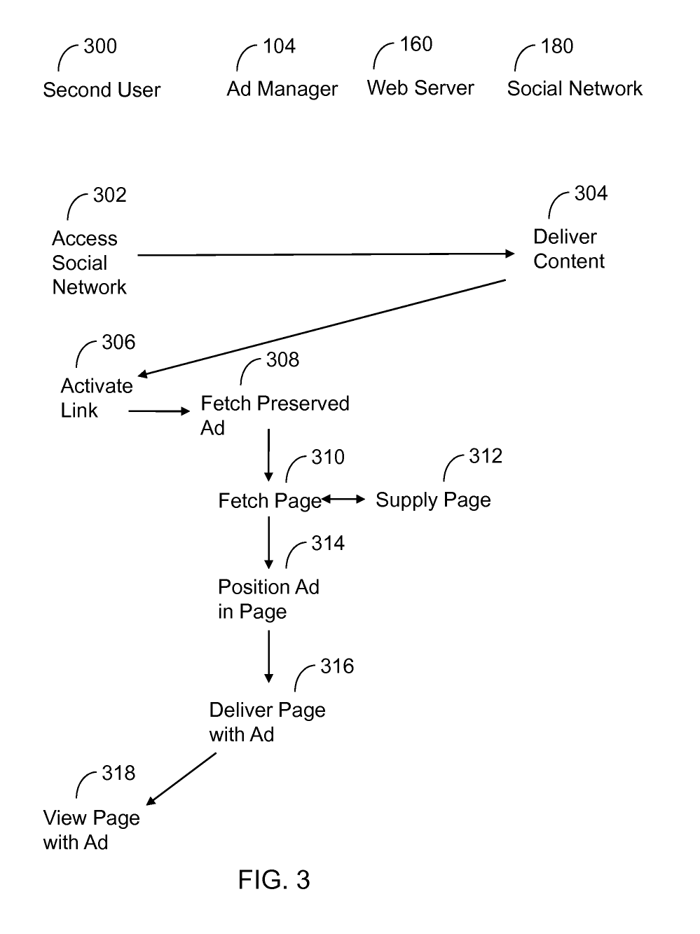

FIG. 3 illustrates subsequent processing operations. In particular, a second user 300 using a second client device 102 accesses her social network 302 (e.g., her Facebook® wall). The social network 180 delivers the requested content 304. The second user 300 activates the link 306. That is, the second user 300 activates the link associated with the text posted by the first user 200.

The activated link specifies an initial call to the advertisement manager 104, which fetches the preserved advertisement 308. The advertisement manager then fetches the original page 310. This typically entails a call to the web server 160 hosting the page. The web server 160 supplies the page 312. The advertisement manager 104 then positions the preserved advertisement in the fetched page 314. Observe here that instead of delivering the fetched page with a dynamically supplied advertisement, the fetched page with the advertisement of interest to the first user 200 is supplied. Therefore, the second user is empowered to have the same user experience as the first user. The web page with the preserved advertisement is then delivered 316. The second user can then view the web page with the preserved advertisement 318.

Thus, the invention provides a technique to allow multiple users to experience the same content and accompanying advertisement. This user experience is not available in the prior art since the fetched content is typically accompanied by a new dynamically served advertisement.

The advertisement manager module 152 may include additional executable instructions to handle ancillary advertisement operations, such as advertisement frequency serving restrictions (impressions per user) and geographic delivery parameters.

The advertisement preservation script may be implemented in any number of ways. However, the overall functionality of the script should include a call to the advertisement manager 104 to preserve an advertisement associated with the script. The script may pass the advertisement to the advertisement manager. The advertisement manager associates the advertisement with a web page address, a user or a session. The advertisement manager may also create a link that includes a call to itself and the address of the original web page. This link may be the posted link in the social network. Consequently, as shown in FIG. 3, activation of the link results in a call to the advertisement manager 104 to fetch the preserved advertisement and a subsequent call to the web server 160 for the original web page.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

In the claims:

1. A computer implemented method, comprising:
fetching a preserved advertisement specified by a first user;
fetching a web page specified by the first user;
positioning the preserved advertisement in the web page; and
delivering the preserved advertisement and the web page to a second user.

2. The computer implemented method of claim 1 further comprising supplying to a server an advertisement with an advertisement preservation script.

3. The computer implemented method of claim 2 further comprising preserving the advertisement in response to activation of the advertisement preservation script.

4. The computer implemented method of claim 1 wherein fetching the web page specified by the first user includes fetching the web page from a web server.

5. A computer implemented method, comprising:
pulling a web page in response to a request;
requesting an advertisement with an associated advertisement preservation script;
combining the web page and the advertisement with the associated advertisement preservation script; and
delivering the web page and the advertisement with the associated advertisement preservation script.

4. A computer implemented method, comprising:
hosting a social network interface including a post from a first user with custom text and a link to a web page with an advertisement with an associated advertisement preservation script; and
delivering, in response to a request from a second user, the link to the web page with the advertisement with the associated advertisement preservation script.
